(19) United States
(12) Patent Application Publication
(10) Pub. No.: US 2024/0076588 A1
(43) Pub. Date: Mar. 7, 2024

(54) DISINFECTING-WIPES PACKAGE

(71) Applicants: Jan Michael TRINKAUS, Euskirchen (DE); Christian Berndt, Aschersleben (DE)

(72) Inventors: Jan Michael TRINKAUS, Euskirchen (DE); Christian Berndt, Aschersleben (DE)

(21) Appl. No.: 18/238,672

(22) Filed: Aug. 28, 2023

(30) Foreign Application Priority Data
Sep. 2, 2022 (DE) 102022122316.7

(51) Int. Cl. C11D 17/04; A01N 31/02; A01P 1/00; A47K 10/42; B65D 75/58; B65D 83/08; B65D 85/62; B65D 85/671; C11D 3/20; C11D 3/40; C11D 3/48; D04H 1/26; D04H 1/4258; D04H 1/4266; D04H 1/4374; D04H 1/492; D06M 13/144; D06M 13/207; D06M 16/00

(52) U.S. Cl. CPC C11D 17/049; A01N 31/02; A01P 1/00; A47K 10/42; B65D 75/5855; B65D 83/0805; B65D 83/0894; B65D 85/62; B65D 85/671; C11D 3/201; C11D 3/40; C11D 3/48; D04H 1/26; D04H 1/4258; D04H 1/4266; D04H 1/4374; D04H 1/492; D06M 13/144; D06M 13/207; D06M 16/00; A47K 2010/3266

(57) ABSTRACT

A package has a container formed with a dispensing opening and a supply of nonwoven disinfecting wipes in the container. The wipes are made of fibers containing lignin and impregnated with a disinfectant solution having at least two liquid components. A lignin content of the nonwoven wipes is between 0.02 g/m² and 1 g/m² and/or the disinfectant solution contains a dye. Thus if at least a part of one of the wipes is overexposed to air, it will change color as oxidized lignin and/or dye collects in it.

### FIELD OF THE INVENTION

The present invention relates to a disinfectant package. More particularly this invention concerns such a package holding disinfecting wipes.

### BACKGROUND OF THE INVENTION

Such a package typically has a container formed with a dispensing opening and holding a plurality of nonwoven wipes impregnated with a disinfectant solution having at least two liquid components.

A high level of hygiene is important for various institutions in health care, nursing, catering and food production in order to protect people in particular from diseases caused by viruses, germs or the like. It is usual to disinfect tools, equipment, surfaces and the like with such wipes.

A particularly high degree of hygiene is for example necessary in medicine in hospitals, medical practices or also care facilities. While medical tools and apparatuses are partly cleaned and sterilized in special sterilizers like autoclaves and disinfected, surfaces such as door handles in buildings must be disinfected. Furniture and also equipment such as hospital beds, wheelchairs or the like must be wiped down for example with such disinfecting wipes.

Disinfecting wipes are soaked with a disinfectant solution that is wiped onto a surface. On the one hand such disinfectant wipes can remove superficial dirt, while on the other hand they also coat the surface with the disinfectant solution. This way in particular bacteria, viruses and germs at least in a substantial measure are killed and/or neutralized.

The disinfectant solutions widely used in practice have at least two liquid components, for example alcohol and water. The mixture of the components produces an efficient disinfection effect, and still further additives like for example a pH-regulator can be provided.

From the point of view of a user it is clear that the disinfecting wipe must be at least moist to ensure the desired disinfecting function. The correct material composition of the disinfectant solution cannot however be determined by the user with known disinfecting cloth wipes.

More particularly, the known disinfecting-wipe package has a usually reclosable dispensing opening. On the one hand simple film packages with a reclosable fastener are common, as for example in DE 10 2007 035 501 A1 and DE 10 2007 036 903 A1. Furthermore also dispenser cans are known from which the disinfecting wipes are drawn individually from an upper dispensing opening.

Due to the reclosability of the dispensing opening, after a first opening of the receptacle, use over a relative long period is possible. However, in practice there is the danger that the closure is incomplete so that the disinfecting function of the disinfecting wipes can be impaired. Thus it is possible, that a reclosable dispensing opening is deliberately or accidentally not closed properly and/or an end of a disinfecting wipe is left with its end hanging out despite an at least partial closure of the withdrawal opening.

Also, if several disinfecting wipes are to be removed one immediately after the other, the dispensing opening need not be closed between withdrawals. If the dispensing opening is not closed for a short period, the functionality of the disinfecting wipes usually is not impaired.

If however a disinfecting wipe is exposed to air for a long period, the liquid components of the disinfectant solution volatilize, and then the necessary disinfecting effect can no longer be achieved,

Especially with the described disinfectant solutions with at least two liquid components one must also take into account that the two different components as a rule volatilize differently. If the disinfectant solution has, for example alcohol and water, the former volatilizes much faster than the latter so that the volume ratio of the two components changes continuously.

If the alcohol content falls below a limit, the disinfecting effect is not adequate. However, even if the alcohol has evaporated mostly or completely, the aqueous fraction of the disinfectant solution is still present. The disinfecting wipe is thus still moist. This can give the user the false impression that the disinfection cloth is still usable, even though actually the disinfecting effect has been partly or completely lost.

### OBJECTS OF THE INVENTION

It is therefore an object of the present invention to provide an improved disinfecting-wipe package.

Another object is the provision of such an improved disinfecting-wipe package that overcomes the above-given disadvantages, in particular that there is an increased degree of safety.

In particular, a user should be able to detect, if the disinfecting properties of a still-moist disinfecting wipes are impaired due to a change in the composition of the disinfectant solution.

### SUMMARY OF THE INVENTION

Thus, a package has according to the invention a container formed with a dispensing opening and a supply of nonwoven disinfecting wipes in the container. The wipes are made of fibers containing lignin and impregnated with a disinfectant solution having at least two liquid components. A lignin content of the nonwoven wipes is between 0.02 g/m² and 1 g/m² and/or the disinfectant solution contains a dye.

Both the dye as and a decomposition in particular by oxidation of the lignin can create in a partially exposed disinfecting wipe striking color changes. This applies in connection with the wipes according to the invention having an at least two-component liquid disinfectant solution in which the at least two components as a rule always have different behaviors with respect to migration and its volatilization.

For example, if according to a preferred embodiment of the invention the aqueous disinfectant solution contains alcohol at a volume fraction between 50% and 90%, in particular between 55% and 80%, and water with a volume fraction between 10% and 55%, in particular between 20% and 45% has, the alcohol much more volatile than the water and will evaporate at the exposed site of the disinfecting wipe correspondingly rapidly. Suitable alcohols include ethanol, 1-propanol and 2-propanol also known in practice as isopropanol. Mixtures of different alcohols are also particularly suitable.

If the disinfecting wipe is only exposed to air for a short time, this loss of alcohol usually plays no role and the disinfecting effect is still not lost. If on the other hand a section of the disinfecting cloth is exposed over a longer period, then a correspondingly larger amount of alcohol will evaporate and also be transported by capillary action into the exposed part. There exists thus a considerable danger that even with a small exposed section only of a disinfection cloth not only the partly exposed disinfection cloth itself but also adjacent disinfecting wipes or the entire receptacle lose substantial amounts of the more readily volatile component, thus in particular alcohol.

Especially such increased capillary migration leads also to the dye present in the disinfectant solution or the lignin present in the nonwoven or decomposition products thereof migrate by capillarity with the volatile component to the exposed part of the wipe. Accordingly then these colored or coloring components are concentrated locally in the exposed part and a specific local discoloration results, which a user can easily perceive.

For example, when a single disinfecting wipe is removed from the container, the section with an increased amount of lignin and/or dye is clearly different from the rest of the disinfecting wipe.

This applies in particular, if the user is referred to the functionality described for quality assurance by explanatory notes, for example in a manual, a package insert or the like that point out that a visible, in particular local, discoloration of a disinfecting wipe and usually also the entire disinfecting-wipe package can no longer be safely used.

According to a preferred embodiment of the invention the disinfectant solution has a pH-regulator. The pH-regulator can thereby set for the disinfectant solution a pH of less than 5.8 and preferably more than 3.5.

Suitable raw materials include malic acid, both dextrorotatory (D-) and levorotatory (L-) malic acid being suitable. Tartaric acid, fumaric acid, citric acid or succinic acid, for example, can also be used additionally or alternatively.

With such a pH on the one hand the cleaning and disinfecting effect can be adjusted or influenced. At the stated low levels there is no problem with direct skin contact with a user, if without gloves or other protective measures surfaces are cleaned and/or the hands are to be disinfected.

If the nonwoven according to a variant of the invention contains lignin, then the decomposition products of lignin lead to a yellow or brown discoloration. In this is assumed that oxidation of lignin by an acidic environment at a pH less than 5.8 creates in the lignin a higher level of staining decomposition products that then, as previously described, are transported by a migration of a liquid component of the disinfectant and accumulate in particular there, where the corresponding component is volatilized or evaporates.

The transport and accumulation described are present in principle using fibers that are already bleached to a certain extent and in relation to the quantity distribution of wood as starting product only still have a comparatively small content of lignin.

The nonwoven can be formed in the framework of the invention without limitation with a plurality of layers. Each layer can be thereby formed from a respective fiber type or from a respective fiber blend.

According to a preferred embodiment of the invention at least one layer of the nonwoven contains a lignin-containing wood-fiber material. The wood-fiber material may be pulp for example formed by the comminution of wood with a hammer mill. The term pulp is thereby not limited to an aqueous slurry of fibers, but also includes merely moist or also dry fiber masses. The proportion of pulp in the at least one layer with lignin-containing wood fiber pulp can be in particular in a range from 70% to 100% by weight.

The pulp can be bleached and in particular without chlorine so that in the comparison to wood only still a reduced portion of lignin is present, that however is sufficient for the desired color change with the described processes.

In the framework of the invention for example a multilayer structure of the nonwoven a layer is completely or substantially formed from pulp. Due to the soft consistency of the fibers, in particular in an at least three-layer structure, the arrangement of the layer of pulp can be provided as a core layer sandwiched between two outer layers.

In the context of the invention it is also possible, that the nonwoven does not contain lignin and then the described dyeing effects are achieved exclusively by the dye of the disinfectant solution.

As described below still further, a combination of lignin in the nonwoven and dye in the disinfectant leads to a particularly distinct color change, which is why such a combination may be particularly useful in the context of the invention.

Regardless of the presence of lignin, according to a preferred embodiment of the invention the nonwoven comprises at least a layer of a natural fiber or a plant-based material.

As plant-based material for example regenerated cellulose, in particular in the form of viscose, comes into consideration as it can be obtained by chemical processes from cellulose-containing raw materials such as for example wood. In contrast to pulp however a material processing and/or conversion is provided whereby viscose fibers are spun for example in a wet spinning process in form of filaments.

For example, at least one layer containing viscose fibers can be provided that consists of 70% to 100% by weight viscose fibers, in particular viscose staple fibers.

According to a particularly preferred embodiment of the invention the nonwoven is entirely formed from biodegradable, plant-based materials. If, for example, the nonwoven has only layers of viscose and/or pulp, the material is both thermally recyclable and also biologically degradable, in particular compostable and decomposable.

The use of the disinfecting wipes in medicine is thereby however itself understandable with a disinfection process that takes up viruses, stimulants, bacteria or the like and also frequently with the further handling of the disinfecting wipe in the context of disposal that may not be controlled.

A three-layer structure is for example suitable, with a core layer of pulp between outer layers of viscose. The viscose fibers may be deposited for example with a carding device process, where the deposition of pulp may be done for example by an air stream or from an aqueous suspension. Optionally, the nonwoven may be consolidated during its manufacture for example by water jets and subsequently dried.

The nonwoven has according to a preferred embodiment a basis weight between 25 g/m² and 80 g/m².

If the coloring substance or a precursor for a coloring substance is lignin, the nonwoven is between 0.02 g/m² and 1 g/m², preferably between 0.05 g/m² and 0.2 g/m², more preferably between 0.07 g/m² and 0.14 g/m² lignin. As already previously explained, pulp or an alternative lignin of fiber material may be bleached to a certain degree. In this case, the lignin proportion is also determined on the basis of a Kappa number according to ISO 302:2015.

In addition or alternatively according to a preferred embodiment of the invention, the disinfectant solution contains dye in a portion for example between 0.01 mg/l (milligrams per liter) and 2 mg/l, preferably between 0.02 mg/l and 1 mg/l, particularly preferably between 0.1 mg/l and 0.5 mg/l. Suitable dies are in particular food dyes, natural dyes and nature-identical dyes that as a rule are harmless to a user and the environment. Natural dyes and nature-identical dyes are often classified as food dyes.

The dye is used in sufficient quantity that cleaned surfaces have no or at least no detectable substantial coloration is detectable. By the migration of the dye on volatilization of at least one of the at least two liquid components of the disinfectant solution, the dye can then accumulate where the evaporation takes place, normally an exposed end of a wipe, so that locally a perceptible color change occurs. Suitable dies are for example synthetically produced food dyes such as patent blue V and quinoline yellow.

Furthermore, natural or nature-identical dyes, which themselves may also be classified as food dyes, can be considered. Depending on the composition of the disinfectant solution, the solubility of the dye must be taken into account. In the case of a disinfectant solution formed from water and alcohol, water-soluble dyes such as chlorophylls, anthocyanins, flavones and betalains are generally suitable.

Chlorophyll, also called leaf green, refers to a class of natural pigments formed by organisms that carry out photosynthesis. Anthocyanins are water-soluble plant pigments that occur in the cell sap of almost all higher plants and give flowers and fruits an intense red, purple or blue color. Natural sources of anthocyanins include elderberries, red cabbage, blueberries, blackberries, black currants, blue grapes, privet berries, hollyhocks and corn poppies. Flavones exhibit a yellow to orange light brown color and can be obtained, for example, from kitchen onion, birch, hops, woof, sage, and goldenrod. betalains, in particular, can be obtained from red beets such as beet. Depending on the composition of the disinfectant solution, non-water-soluble natural colorants such as carotenoids may also be considered, if necessary.

In the case of the natural colorants mentioned, it should be noted that these substances obtained from natural products may have other specific properties in addition to their coloring effect. It is understood that natural dyes are preferably used that are physiologically harmless. Furthermore, natural dyes may also have further beneficial properties within the scope of the invention, such as a disinfecting effect.

In a known manner the receptacle may be formed as resealable film package or as dispenser can. The receptacle in its delivery state holds for example between 50 and 200 disinfecting wipe, in particular between 60 and 120 disinfecting wipe. The receptacle on the one hand is fairly compact while on the other hand it holds enough disinfecting wipes for usual tasks. In the context of the invention is one must also take into account that in case of the above-described color change, the entire disinfecting-wipes package should probably no longer be used.

According to a preferred embodiment of the invention, the disinfecting wipes in the container lie against each other and/or are folded into each other and/or are separable from each other as strand connecting to each other. In the case of such a strand, the disinfecting wipes can, for example, be connected at a perforation line that can then be separated by hand or automatically when individual disinfecting wipes are pulled out of the receptacle at the dispensing opening. The strand may also be thereby formed as a roll in the container. Such an arrangement is particularly suitable in connection with a dispenser can as receptacle.

In the film package according to the invention the disinfecting wipes are usually also folded. The disinfecting wipes can thus be in a simple stack lying on top of one another. Preferably, however, the successive disinfecting wipes are folded into each other, so that the removal of a disinfecting wipe also pulls the immediately underlying disinfecting wipe at least partially out through the dispensing opening. The following disinfecting wipe can then be especially easily and reliably grasped.

The disadvantage can however result, that in case of an excessive accidental pulling out of the following disinfecting wipe a proper closure of the dispensing opening is no longer possible or at least is impaired and then over a long period in the described manner one of the at least two liquid components is lost. Such a situation can then be reliably detected within the framework of the invention.

### BRIEF DESCRIPTION OF THE DRAWING

The above and other objects, features, and advantages will become more readily apparent from the following description, reference being made to the accompanying drawing in which:

FIG. 1 is a partly sectional perspective view of the package of this invention;

FIG. 2 is another such view of another package according to the invention; and

FIG. 3 is a schematic view illustrating a system and method for making the inventive package.

### SPECIFIC DESCRIPTION OF THE INVENTION

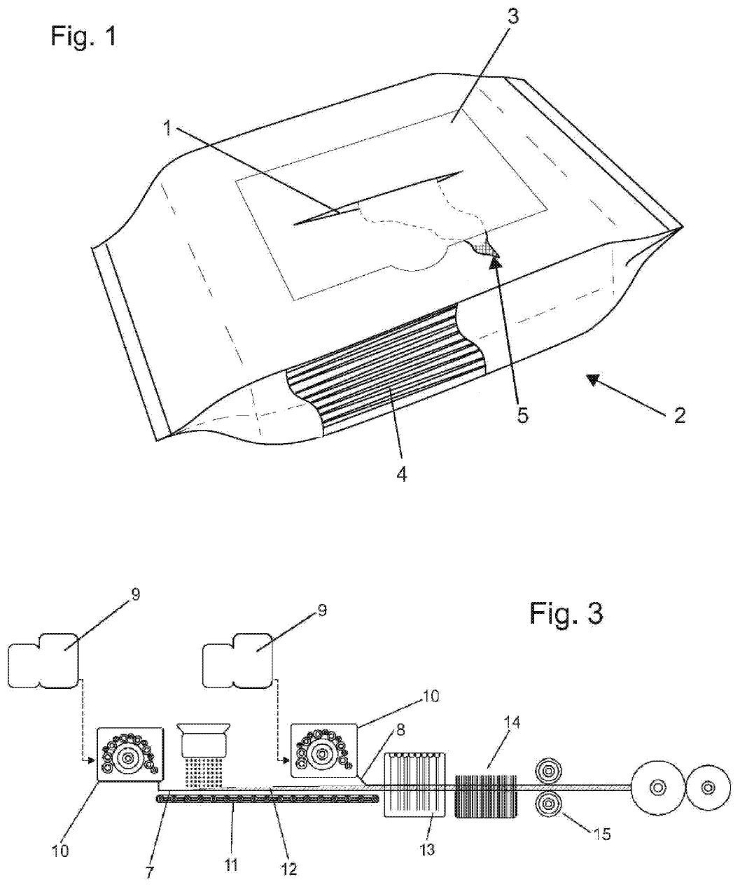

As seen in FIG. 1 a bag-like container 2 made of film has an opening 1 that can be closed by a self-adhesive film patch 3. The container 2 holds a plurality of for example 60 or 80 disinfecting wipes 4 made of nonwoven sheets. The disinfecting wipes 4 are folded into each other as is known so that when pulling out a disinfecting wipe 4 the next is automatically pulled to and through the dispensing opening 1.

The disinfecting wipes 4 are soaked with a disinfectant solution having two liquid components. The disinfectant solution may have for example as liquid components alcohol with a volume content between 50% and 90% and water with a volume content between 10% and 50%, and small quantities of individual additives can be provided. Suitable alcohols are for example ethanol, 1-propanol and 2-propanol that in practice also is called isopropanol. In particular, mixtures of different alcohols may be considered.

As further components the disinfectant solution has a pH-regulator such as malic acid that sets a pH value below 5.8 and for example between 3.5 and 5.8.

Finally, there is also between 0.02 mg/l to 1 mg/l of food color is added. Suitable are for example the food dyes quinoline yellow and patent blue V.

According to a specific embodiment the disinfectant solution can be for example 27 vol % ethanol, 36 vol % isopropanol, 36 vol % water, 1% pH-regulator in form of malic acid and the specified amounts of dye.

Furthermore, the nonwoven comprises lignin-containing fibers. The nonwoven may be in particular formed from biodegradable plant-based materials and have a basis weight between 25 g/m² and 80 g/m². For example, the lignin content is between 0.05 g/m² and 0.2 g/m².

Table 1 below shows an embodiment of an inventive nonwoven material.

TABLE 1

| | | | | | | Fiber |
|---|---|---|---|---|---|---|
| | Basis | | Composition | Fiber | | fineness/ |
| Function | weight | Technology | of fibers | length | | diameter |
| First outer layer | 18 g/m² | Carded | 100% viscose | 38 | mm | 1.7 dtex |
| Core | 20 g/m² | Air laid | 10% pulp | 2.9 | mm | 24 mg/100 m |
| Second outer layer | 12 g/m² | Carded | 100% viscose | 38 | mm | 1.7 dtex |

According to FIG. 1, one of the originally contained disinfecting wipe 4 has been pulled wholly from the container 2 but the following disinfecting wipe 4 is pulled partially out of the dispensing opening 1 so that it projects outward past the film patch 3 and thus an exposed end 5 of it is not covered.

In the inventive aqueous disinfectant solution the ethanol and/or isopropanol alcohol component is slightly more volatile than the other component, water, and evaporates at the exposed end 5. Thus capillarity or diffusion of this component occurs in the disinfection cloths 4 of only the more volatile fraction as the alcohol continuously vaporizes.

This applies not only to the outermost disinfecting wipe 4 whose exposed end 5 projects from the receptacle 2, but also for the underlying disinfecting wipes 4 that are all in direct contact with one another.

Especially over a long period, large amounts of alcohol can evaporate, so that overall the desired disinfecting effect is no longer present. Nonetheless, the less volatile component, the water, has not vaporized so that the exposed end 5 of the uppermost disinfecting cloth 4 is still moist. However, according to the invention a clearly perceptible color change is observed in the exposed part.

This is due to the fact with the alcohol migrating outward to outside the container 2 carries outside to the free end 5 alcohol lignin or coloring oxidation products of lignin and the dye contained in the disinfectant solution, and they remain there on evaporation of the alcohol. Thus an accumulation of lignin or coloring decomposition products as well as of the dye is observed at the hanging-out free end 5.

The color change indicates to a user that the contents of the disinfection cloth container can no longer be reliably used because the composition of the disinfectant solution overall has changed significantly. The user can be referred by appropriate notices on the receptacle 2, a manual or a package insert to this functionality.

In comparison to a disinfecting wipe package according to the state of the art, the instant invention results in an increased degree of safety, even when the exposed end 5 is still moist due to the presence of the less rapidly volatile water. Without the described color change it is impossible for a user with a disinfecting wipe package according to the state of the art to determine if the disinfecting-wipe package still can be used if the part 5 still feels wet.

If on the other hand no color change is present, the user will know that the exposed end 5 of the uppermost disinfecting wipe 4 has not yet led to a deterioration of the entire disinfecting wipe supply. The user may then conclude that the end 5 has not been exposed for too long while alcohol, the more readily volatile component, has diffused out and the composition of the disinfectant solution is substantially changed.

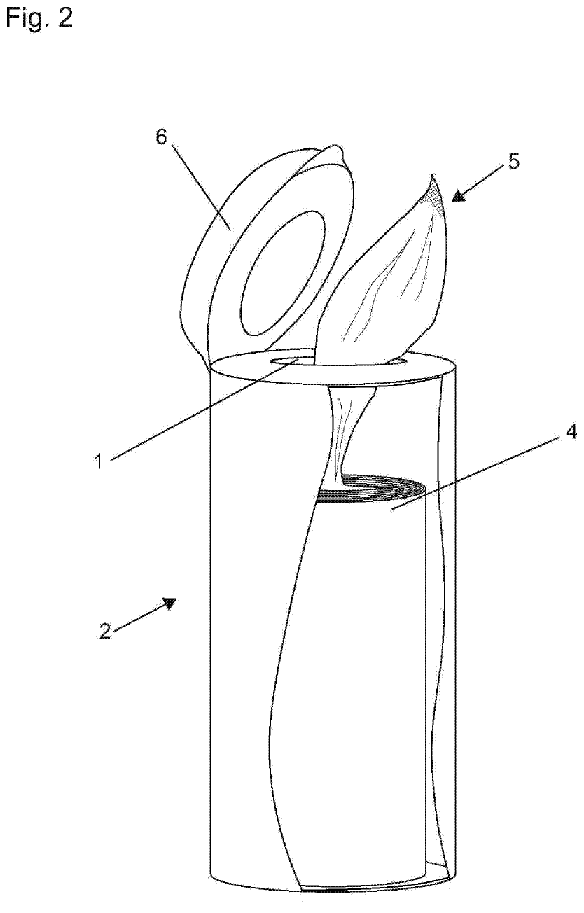

FIG. 2 shows an alternative embodiment of the disinfecting wipes container 2 that is constituted as a dispenser can. The dispensing opening 1 can be closed with a lid 6. FIG. 2 shows an embodiment where the lid 6 is not properly closed, and here also here uppermost disinfection cloth 4 has an exposed end 5 that projects from the dispensing opening 1 and there a substantial color change is recognizable. Also here the user can clearly see that the entire disinfection package can no longer be used safely.

FIG. 3 shows a process for making the nonwoven from which the disinfecting wipes 4 are formed. For a first outer layer 7 and a second outer layer 8, in each case viscose fibers are provided as from supplies 9 and then fed to a carding device 10. The upstream card 10 feeds the first outer layer 9 onto on a conveyor 11 and then a core layer 12 of pulp is deposited in an air stream. Then the core layer 12 is covered with the second outer layer 8 from a respective card 10 before the material web is fed through to a consolidator 13 for densification by high-pressure water jets and thence through a dryer 14. An exemplarily shown pair of calender rolls 15 are also shown as a final thermal-consolidation step. Finally the material web can be wound up and subsequently further processed.

We claim:

1. A package comprising:
a container formed with a dispensing opening; and
a supply of nonwoven disinfecting wipes in the container, the wipes being made of fibers containing lignin and impregnated with a disinfectant solution having at least two liquid components, a lignin content of the nonwoven being between 0.02 g/m² and 1 g/m² and/or the disinfectant solution containing a dye.

2. The package according to claim 1, wherein the liquid components of the disinfectant solution are alcohol with a volume fraction between 50% and 90% and water with a volume fraction between 10% and 50%.

3. The package according to claim 1, wherein the disinfectant solution has a pH regulator and the disinfectant solution has a pH between 3.5 and 5.8.

4. The package according to claim 1, wherein the nonwoven has at least one layer containing a lignin-containing wood fiber material.

5. The package according to claim 4, wherein the layer of the nonwoven with lignin-containing wood pulp consists of 70% to 100% by weight of pulp.

6. The package according to claim 1, wherein the nonwoven has a plurality of layers of which at least one layer contains fibers of regenerated viscose fibers.

7. The package according to claim 6, wherein the one layer containing viscose fibers consists of 70% by weight to 100% by weight of viscose staple fibers.

8. The package according to claim 1, wherein the nonwoven has three layers.

9. The package according to claim 1, wherein the nonwoven is formed entirely of biodegradable plant-based material.

10. The package according to claim 1, wherein the nonwoven has a basis weight between 25 g/m² and 80 g/m².

11. The package according to claim 1, wherein the nonwoven comprises between 0.05 g/m² and 0.2 g/m² lignin.

12. The package according to claim 1, wherein the disinfectant solution contains between 0.02 mg/l and 1 mg/l of the dye.

13. The package according to claim 12, wherein the dye is a food dye, a natural dye, or a nature-identical dye.

14. The package according to claim 1, wherein the container is a reclosable film package or a dispenser can.

15. The package according to claim 1, wherein the supply contains between 50 and 200 of the disinfecting wipes.

16. The package according to claim 1, wherein the disinfecting wipes lie against one another in the container and/or are folded into one another and/or connect to one another separably as a strand.
